(19) United States
(12) Patent Application Publication
(10) Pub. No.: US 2013/0116918 A1
(43) Pub. Date: May 9, 2013

(54) DEVICE INTENDED FOR AIR TRAFFIC CONTROLLERS FOR AIDING TRACKING OF AIRCRAFT CLIMBS AND DESCENTS

(71) Applicant: Jean-Philippe Pinheiro, Rungis (FR)

(72) Inventor: Jean-Philippe Pinheiro, Rungis (FR)

(73) Assignee: Thales, Neuilly-Sur-Seine (FR)

(21) Appl. No.: 13/516,354

(22) PCT Filed: Dec. 17, 2010
(86) PCT No.: PCT/EP2010/070142

§ 371 Date: Dec. 17, 2012

(30) Foreign Application Priority Data
Dec. 18, 2009 (FR) 09/06176

(51) Int. Cl. G08G 5/00

(52) U.S. Cl. CPC G08G 5/0026
USPC 701/120

(57) ABSTRACT

The device, intended for air traffic controllers and for assisting the tracking of aircraft ascents and descents, includes: a means for receiving data transmitted by an aircraft, said data including at least the spatial position of the aircraft and requests that are optionally transmitted by the crew; a display making it possible to display the path of a moving aircraft with a view to returning to a first altitude; and a means for giving the aircraft crew permission to reach a second altitude. The device includes an alarm manager that is configurable according to at least one aircraft flight condition calculated on the basis of the first altitude, thus enabling transmission of an alarm at a point in time when the condition is fulfilled.

The invention lies in the field of the man machine interfaces of a civil or military air traffic control station. More precisely, the field of the invention relates to devices making it possible to warn or to alert a controller that an aircraft is going to level off at an altitude level,

Currently, the air traffic controller authorizes the aircraft to attain a certain flight level. A flight level is often called a level or a CFL, the acronym standing for the terminology used in aeronautics “Cleared flight Level”. Generally, the crew defines a cruising level that it wishes to attain.

When the controller gives a CFL, the crew attains the latter whether by climbing or descending.

These procedures may arise throughout the flight, notably after takeoff or during the flight subsequent to a reprogramming of the flight plan in order to avoid bad weather or for a few reasons that may arise.

If an aircraft is climbing, the controller may be led to grant the CFL requested by the crew, that is to say generally at the cruising level of an aircraft but the controller may also assign a lower CFL than the level requested by the pilot for safety reasons.

For example, when another aircraft wishes to reach and fly at a certain level, the controller must wait to see how the situation evolves before responding favorably to the request.

In this case, the controller must regularly check the situation so as to see whether or not he can give the authorization to climb higher or to descend lower than the current situation of the aircraft.

But, for reasons of coordination, given the organization of the control, it is also possible that the controller must request the authorization from the adjacent sector if the requested level is outside of his zone of responsibility. A section cut from the airspace so as to apportion the workload over several controllers is called a sector.

Generally, the air traffic controllers are apportioned the space by zone, each Zone comprising a given perimeter and an altitude slice. When aircraft change slice, the controllers coordinate with one another so as to properly follow an aircraft crossing a level.

On account of this coordination, the air traffic controller may be led to give the crew of the aircraft an intermediate flight level. Even if this intermediate level is not that desired by the crew, it affords the controller some time in order to achieve coordination.

In order to prevent the aircraft from leveling off at a level intermediate to this altitude level which is not the one desired, the controller must dispatch a new altitude clearance before the aircraft arrives at its intermediate level scheduled in such a way that the new clearance is taken into account.

Now, with the workload, a drawback is that the air traffic controller may be led to focus on another point and to forget to give the crew a new directive. This results in the aircraft being left to fly the level scheduled in its flight plan although nothing was stopping it from continuing its climb. The aircraft is therefore arrested in its climb or its descent and therefore has a needless overconsumption.

A problem encountered is that no aid exists for alerting the controller that an aircraft is going to level off at an intermediate level.

The only means is to undertake periodic monitoring of the altitude of the aircraft. The controller must therefore monopolize a large part of his attention for the monitoring of an aircraft to the detriment of other actions.

He can perform this monitoring on the basis of radar tracks on a control screen or else on the basis of the display indicating the tracking of the vertical trajectories of aircraft included in a portion of space.

An aim of the invention is to alleviate the aforementioned drawbacks.

An aim of the invention is notably to relieve the air traffic controller by means of a device making it possible to generate an alarm when the aircraft is approaching an altitude level or a level at which a decision of the controller must be taken.

For this purpose, the subject of the invention is a device intended for air traffic controllers for aiding the tracking of the climbs and descents of aircraft, comprising:
means for receiving data emitted by an aircraft comprising at least its position in space and possible queries emitted by the crew;
a display making it possible to display the trajectory of an aircraft performing a maneuver with a view to attaining a first altitude level and; means for giving the crew of the aircraft authorization to reach a second altitude level.

The device comprises an alarms manager configurable according to at least one flight condition of the aircraft calculated on the basis of the first altitude level making it possible to emit an alarm at an instant at which the condition is fulfilled.

The condition may be a threshold of altitude remaining to be crossed until the first altitude level, the alarm being triggered when the value of the threshold is crossed by the aircraft.

The condition may be a predefined duration before reaching the first altitude level, the alarm being triggered when the time remaining for the aircraft to attain the first altitude level is less than the predefined duration.

Advantageously, the display generates an indicator on the trajectory of the aircraft indicating the moment at which the alarm will be triggered.

Advantageously, the alarm is a visual alarm displayed on the display of the air traffic controller or an alarm is an audible alarm,

Advantageously, the alarm is displayed superimposed on the trajectory of the aircraft at the level of the symbol representing the aircraft.

The invention will be better understood and other advantages will become apparent on reading the nonlimiting description which follows and by virtue of the appended figures among which

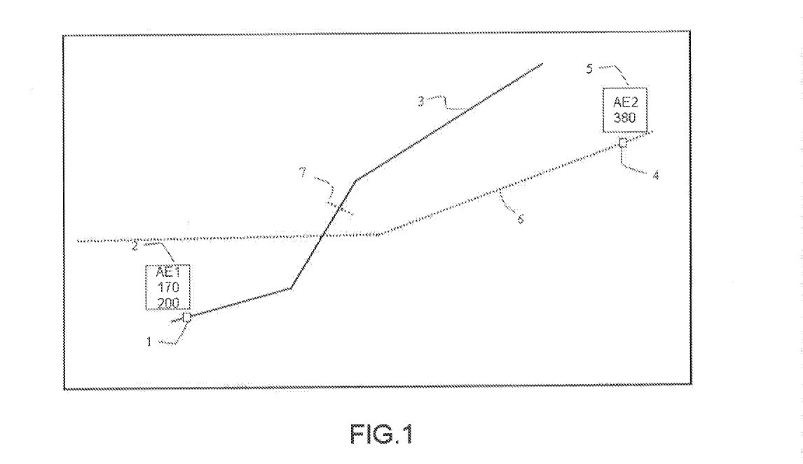

FIG. 1 represents an air traffic control screen indicating the position of certain aircraft, their flight plan and an alarm indicator according to the invention.

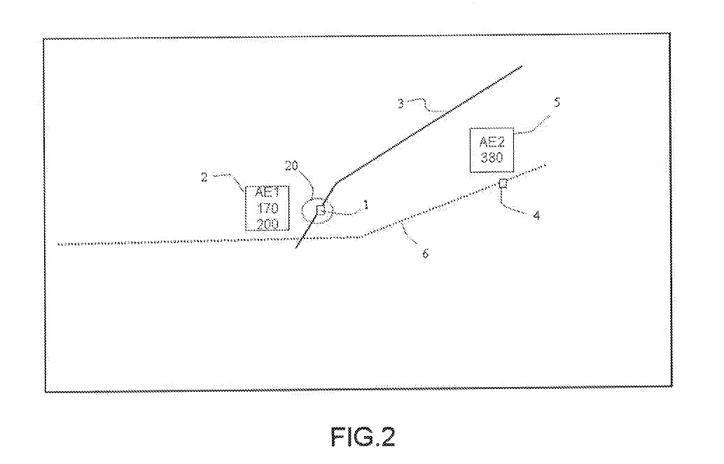

FIG. 2 represents an air traffic control screen indicating a visual alarm around the symbol of the monitored aircraft.

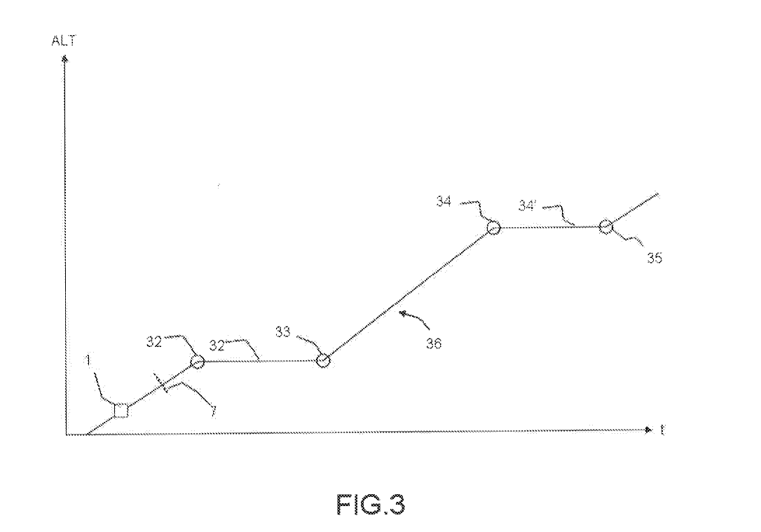

FIG. 3 represents a vertical cut through the flight plan and a marker indicating the presence of an alarm to the controller.

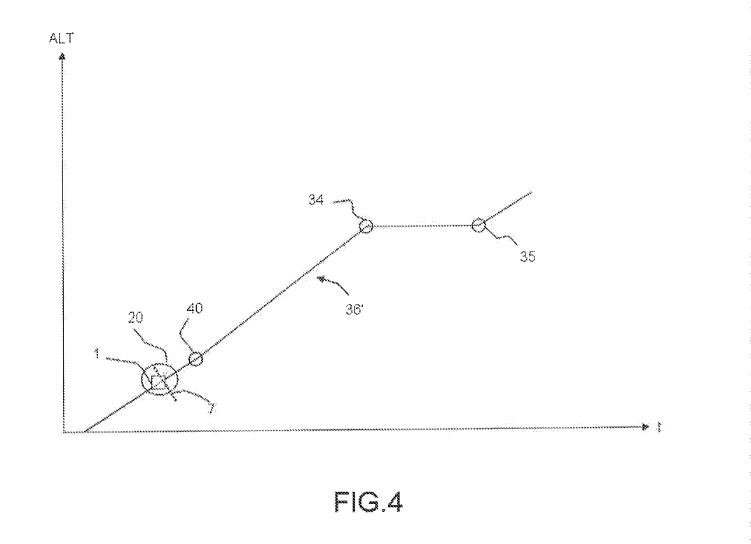

FIG. 4 represents a vertical cut through the modified flight plan after reception of a clearance from the controller.

In the subsequent description, when an aircraft is flying its flight plan, the next level to he reached by the aircraft whatever its situation is called: the “next level” and the level situated after the next level is called: the“second level”.

In the subsequent description reference is made interchangeably to a level and an altitude level to be reached, the latter generally being given by the air traffic controller.

FIG. 1 represents a viewing screen allowing an air traffic controller to monitor a portion of the airspace which corresponds to his sector.

When aircraft changes slice, the controllers coordinate with one another so as to properly follow an aircraft crossing a level.

in the display, an aircraft 1, denoted AE1 in the block 2, follows a flight plan 3. It flies at an altitude of 17000 feet and must reach an altitude of 20000 feet. This information is given in the block 2 so as to inform the controller of the trajectory followed by the aircraft 1. For example, in FIG. 1, the aircraft 1 performs an climb from a level at 17000 feet to a level at 20000 feet.

A second aircraft 4, denoted AE2 in a second block 5 flies at a fixed altitude of 38000 feet according to its flight plan 6.

The controller therefore views the trajectories of various aircraft whose flight plans pass through his sector.

The invention makes it possible to generate an alarm at an instant determined by a marker 7 represented on the flight plan 3. The marker 7 is an indication calculated by the system and indicating the point where the alert will be triggered. This indication is visible only to the controller in charge of the sector. It indicates the presence of an alarm the aim of which is to inform the controller of the imminence of the arrival of the aircraft at its next level which in the example of FIG. 1 at 20000 feet.

Notably, the invention makes it possible to generate an alarm when the aircraft is approaching its next level, the latter being input by the controller.

In one embodiment, this alarm may be triggered a certain number of seconds before attaining the next level of the aircraft, for example 60 seconds before reaching it.

In the case of an alarm triggered a certain number of seconds before reaching the next level of the flight plan of the aircraft 1, a calculation on the basis of the radar tracks makes it possible to estimate the vertical speed of the aircraft and thus to calculate the time remaining in order to attain said level.

In another embodiment, the alarm may be triggered at a certain altitude before attaining the next level, for example 1500 feet before the level.

In the example of FIG. 1, the alarm will be triggered at 18500 feet before reaching the level of 20000 feet.

FIG. 2 represents the same view but a few minutes later. As the aircraft 1 approaches its level at 20000 feet, it passes through the point indicated by marker 7 situated in this example 1500 feet below the level at 20000 feet, i.e. at an altitude of 18500 feet.

In this example, the symbol 1 representing the aircraft is surrounded by a second symbol 20 representing a halo. The visual alarm makes it possible to capture the controller's attention so as to lead him to act with a view to communicating a clearance to the pilot.

The controller can then dispatch a clearance to the pilots indicating that the aircraft can continue its climb until the second level, the second level being the level defined after the next level. For example, this may involve a second level at 30000 feet, without. marking the next level at 20000 feet.

The clearance may be transmitted to the crew orally by the controller.

In other variant embodiments, the alarm may be for example a sounded/audible alarm emitting a specific sound making it possible to warn the controller of the imminence of its arrival at the next level mentioned on the flight plan of the aircraft.

The invention also makes it possible to indicate in the controller's timetable the moment at which the alarm will be triggered. The controller can at any moment consult his timetable and see the time remaining to him to evaluate whether or not it is possible to continue the climb or the descent without the aircraft flying to the next level.

This moment can also be displayed on the flight plan by a graphical symbol.

An advantage of the invention is that this alarm allows the controller to focus on the other tasks. Thus, he no longer needs to periodically monitor the climb, respectively the descent, of the aircraft, because the moment at which he must make a decision will be indicated to him by the alarm.

An advantage of the invention is the ability to circumvent needless levels scheduled in the flight plan and which do not have to be flown by an aircraft wishing to continue its climb.

FIG. 3 represents the vertical cut through a flight plan 36 in a reference frame whose ordinate axis represents altitude, denoted ALT, and whose abscissa axis represents time, denoted t. The flight plan 36 is generally programmed on the ground by the pilots in order to perform a flight corresponding to a given mission.

In the flight plan 36, the aircraft 1 commences a first climb phase making it possible to reach a first level 32′ after crossing a waypoint 32, The aircraft in theory continues on to a new waypoint 33 to commence a second climb phase. The aircraft then climbs to a level 34′ while passing through a waypoint 34 before reaching another waypoint 35.

If the aircraft is upstream of the point. 32 as represented in FIG. 3, the next level is the level 32′ and the second level is the level 34′ with the definitions specified before.

The marker 7 indicates when the alarm recorded by the controller will be generated to remind him that at that moment he might have to dispatch a clearanceto the crew of the aircraft 1.

Indeed, FIG. 4 represents the case of FIG. 3 when the aircraft crossed the point 7 of its flight plan. It is no longer very far from reaching its waypoint 32 and the controller judges that nothing is stopping the aircraft from climbing directly to the level 34′.

The controller dispatches a clearanceto the crew of the aircraft 1 indicating that it can continue its climb directly to the second level.

In this case the crew redefines a flight plan sequence omitting the level 32′. A new flight plan 36′ is thus generated and the waypoint 32 becomes a simple point 40 situated on the aircraft's climb trajectory.

This solution to the advantage of saving flight time, of simplifying the operations for managing aircraft flying level levels, notably this maneuver makes it possible to decrease the number of levels, Furthermore the invention makes it possible to decrease fuel consumption throughout the flight.

The invention also applies to descent levels according to the same principle.

1. A device intended for air traffic controllers for aiding the tracking of the climbs and descents of aircraft, comprising:
means for receiving data emitted by an aircraft comprising at least its position in space and possible queries emitted by the crew;
a display making it possible to display the trajectory of an aircraft performing a maneuver with a view to attaining a first altitude level and;
means for giving the crew of the aircraft authorization to reach a second altitude level,
characterized in that the device comprises an alarms manager configurable according to at least one flight condition of the aircraft calculated on the basis of the first altitude level making it possible to emit an alarm at an instant at which the condition is fulfilled, the condition being a threshold of altitude remaining to be crossed until the first altitude level, the alarm being triggered when the value of the threshold is crossed by the aircraft.

2. A device intended for air traffic controllers for aiding the tracking of the climbs and descents of aircraft, comprising:
means for receiving data emitted by an aircraft comprising at least its position in space and possible queries emitted by the crew;
a display making it possible to display the trajectory of an aircraft performing a maneuver with a view to attaining a first altitude level and;
means for giving the crew of the aircraft authorization to reach a second altitude level,
characterized in that the device comprises an alarms manager configurable according to at least one flight condition of the aircraft calculated on the basis of the first altitude level making it possible to emit an alarm at an instant at which the condition is fulfilled, the condition being a predefined duration before reaching the first altitude level, the alarm being triggered when the time remaining for the aircraft to attain the first altitude level is less than the predefined duration.

3. The device intended for air traffic controllers for aiding the tracking of the climbs and descents of aircraft as claimed in any one of the preceding claims, characterized in that the display generates an indicator on the trajectory of the aircraft indicating the moment at which the alarm will be triggered.

4. The device intended for air traffic controllers for aiding the tracking of the climbs and descents of aircraft as claimed in any one of the preceding claims, characterized in that the alarm is a visual alarm displayed on the display of the air traffic controller.

5. The device intended for air traffic controllers for aiding the tracking of the climbs and descents of aircraft as claimed in any one of the preceding claims, characterized in that the alarm is an audible alarm.

6. The device intended for air traffic controllers for aiding the tracking of the climbs and descents of aircraft as claimed in claim 5, characterized in that. the alarm is displayed superimposed on the trajectory of the aircraft at the level of the symbol representing the aircraft.
